(19) United States
(12) Patent Application Publication
(10) Pub. No.: US 2008/0169581 A1
(43) Pub. Date: Jul. 17, 2008

(54) METHOD OF MANUFACTURING HONEYCOMB STRUCTURE MOLDING DIE

(75) Inventors: Takeshi FUKUSHIMA, Hekinan-shi (JP); Mamoru Oonishi, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/967,886

(22) Filed: Dec. 31, 2007

(30) Foreign Application Priority Data
Jan. 12, 2007 (JP) 2007-4537
Feb. 8, 2007 (JP) 2007-29579

(51) Int. Cl. B29C 33/38

(52) U.S. Cl. 264/219; 83/51

(57) ABSTRACT

A method and water-jet laser processing device for forming a honeycomb structure molding die are disclosed. The water-jet laser processing device includes a bed on which a workpiece is set, a nozzle injecting a high-pressure water stream in a water column onto the workpiece at a recess forming position thereof, a laser head for guiding the laser beam through the water column to be irradiated onto the recess forming position of the workpiece, a window member disposed between the laser head and the nozzle and transmitting and focusing the laser beam through the water column, and moving means for moving the bed and the nozzle relative to each other to shift a laser beam irradiating position along the recess forming position.

### CROSS REFERENCE TO RELATED APPLICATIONS

This application is related to Japanese Patent Application Nos. 2007-4537 and 2007-29579, filed on Jan. 12, 2007 and Feb. 8, 2007, the contents of which are hereby incorporated by reference.

### BACKGROUND OF THE INVENTION

1. Technical Field of the Invention

The present invention relates to method and water-jet laser processing devices for manufacturing honeycomb structure molding dies and, more particularly, to a method and water-jet laser processing device for manufacturing a honeycomb structure molding die for molding a honeycomb structure body.

2. Description of the Related Art

In the related art, there has heretofore been known a method of manufacturing a honeycomb structure molding die for molding a honeycomb compact body using a water-jet laser processing device. The molding die has a large number of hexagonal slits, formed in a honeycomb pattern, which squeeze clayish raw material for thereby forming the honeycomb compact body.

The water-jet laser processing device is comprised of a laser beam generator for generating a laser beam and a high-pressure water supplier for supplying a high-pressure water stream. The laser beam and high-pressure water stream pass through a nozzle and irradiated and injected onto a workpiece, placed on a bed, to process the same.

More particularly, when manufacturing a molding die, a metallic plate serving as a workpiece is set on the bed of the water-jet laser processing device. Then, the laser beam generator generates the laser beam and the high-pressure water supplier creates the high-pressure water stream using, for instance, industrial water. Thereafter, the nozzle injects a water column of high-pressure water while irradiating the laser beam, thereby melting the metallic plate with the laser beam to process the same. During such processing, the nozzle is moved relative to the metallic plate for forming the slits by one row in a honeycomb pattern. That is, a first row of slit recess is formed on the metallic plate in a specified depth and, subsequently, a second row of slit recess is formed, after which these processing steps are repeatedly executed to finish a final row of slit recess. Thus, the metallic plate is formed with the slit recesses in the honeycomb pattern, thereby manufacturing the molding die.

However, with the manufacturing method of the related art, repeatedly executing the steps of processing the slit in the specified depth by one row allows the slit recesses to be finally formed in the honeycomb pattern. Therefore, processing the metallic plate for a prolonged period of time results in a consequence of the laser beam being irradiated onto the same position for the long time. Thus, if a variation occurs in a magnitude or a temperature of energy of the laser beam, it becomes difficult to uniformly process the metallic plate. This causes a variation to easily occur in width of the slit recess for each row with resultant deterioration in processing accuracy.

Further, when forming the slits in a manner described above, water, injected onto a processing area of the metallic plate, escapes through the slit recesses. However, since the slit recesses are formed by one row, an airspace has two directions in which water escapes. Therefore, water tends to easily accumulate in the slit, causing processing wastage to accumulate in the slit. The presence of processing wastage results in a difficulty to perform the processing, causing an increase in processing time.

With the manufacturing method of the related art, further, the nozzle is moved relative to the metallic plate for forming the slits thereon. Therefore, a distortion occurs in the water column of high-pressure water being injected through the nozzle, resulting in an increase in a spot diameter of the laser beam passing through the water column in multiple reflections. This causes a drop in processing efficiency while deterioration occurs in precision of a recess width of the slit recess.

With the manufacturing method of the related art, furthermore, the water column injected from the nozzle is made cloudy, raising mist-like spray. The present inventors have made researches upon dismounting component parts related to a water flow system with a view to investigating causes of distortion of a water flow. As a result, it has been turned out that a foreign particle adheres onto the nozzle while each delivery conduit and component part is contaminated with a slight amount of dusts. That is, these foreign particles were the causes of distorting the water column being injected from the nozzle while causing air bubbles to occur in the water column. The laser beam passing through the water column impinged upon the air bubbles, causing the scattering of the laser beam. This resulted in dispersion of energy of the laser beam, taking increased time for processing the metallic plate.

Meanwhile, various attempts have heretofore been made to provide a method of machining the slit recesses. In recent years, the slit recesses have been increasingly narrowed in width with a resultant difficulty encountered in forming the slit recesses in such a narrowed width with high precision. To address such a difficulty, an attempt has heretofore been made to form the slit recesses using a water-jet laser processing device enabling precise processing to be performed. Such a technology is disclosed in U.S. Pat. No. 7,164,098.

With such a water-jet laser processing device, a nozzle injects a high-pressure water stream onto a slit forming position of a workpiece in a water column, while a laser head emits a laser beam that passes through the water column to be irradiated onto the slit forming position of the workpiece. During such processing, a laser irradiating position is shifted along the recess forming position, thereby processing the slit recesses. In normal practice, the laser irradiating position is shifted along the recess forming position so as to pass the same multiple times, thereby forming the slit recesses each in a targeted depth.

Further, the water-jet laser processing device includes a component part, referred to as a “window”, which is made of material having optical transparency and disposed between the laser head and the nozzle. This window member serves to transmit and focus the laser beam, emitted from the laser head, to cause the laser beam to be incident through the water column. In the related art, it has been a common practice to employ quartz crystal with excellent optical transparency as material of the window member.

However, with the water-jet laser processing device using the window member made of quartz crystal, an issue arises in a manner described below. That is, when processing, for instance, a slit recess in a narrowed width, a high processing accuracy is needed, causing the processing to be performed for a prolonged period of time. With the processing executed in a continuous run for such a prolonged period of time, heat development occurs in the window member on a surface and inside thereof due to the laser beam impinging upon and passing through the window member. This results in deterioration and damage to the window member with a resultant occurrence of cracking or the like.

This causes a variation to occur in light transmission characteristics of the window member, resulting in a fear of a deviation occurring in precision of the laser beam. Therefore, a drop occurs in processing accuracy, causing a fear to occur with a difficulty encountered in forming the slit recess in a desired dimension. In actual practice, to address such a difficulty, the window member has been frequently replaced with a new one within a relatively short period of time.

Accordingly, it has been required to provide a slit recess forming device that can maintain high processing accuracy without causing any defect in the window member even when operated in a continuous run for a prolonged period of time.

### SUMMARY OF THE INVENTION

The present invention has been completed with a view to addressing the above issues and has a first object to provide a method of manufacturing a honeycomb structure molding die that enables slit recesses to be uniformly formed upon improving removing ability of processing wastage while shortening processing time, a second object to provide a method of manufacturing a honeycomb structure molding die that minimizes a distortion in water column being injected from a nozzle, a third object to provide a method of manufacturing a honeycomb structure molding die that can prevent the water column from containing air bubbles and dusts, and a fourth object to provide a water-jet processing device as a slit recess forming device for manufacturing a honeycomb structure molding die that can maintain high processing accuracy even when operated in a continuous run for a prolonged period of time.

To achieve the above object, one aspect of the present invention provides a method of manufacturing a honeycomb structure molding die, operative to form a honeycomb compact body from a clayish raw material which is made of a plate-like member, having one surface formed with guide holes to admit the raw material and the other surface formed with slit recesses in a honeycomb pattern, each having a first depth and held in fluid communication with each of the guide holes, which has a plurality of honeycomb elements divided by the slit recesses, respectively. The method comprises a first step of setting a metallic plate as a workpiece on a water-jet laser processing device including a laser beam generator for generating a laser beam, a high-pressure water generator for creating a high-pressure water stream, a nozzle for irradiating the laser beam, delivered from the laser beam generator, while injecting a high-pressure water stream delivered from the high-pressure water generator, and a bed carrying thereon a workpiece, a second step of causing the high-pressure water stream to be injected from the nozzle in a water column while passing the laser beam through the water column in multiple reflection on a boundary surface between the water column and an outside to cause the laser beam to be irradiated onto the metallic plate for thereby forming slit recesses, each with a second depth shallower than the first depth, on a processing scheduled area, containing the plurality of honeycomb elements, of the metallic plate, and a third step of forming the slit recesses, each with the first depth, on the processing scheduled area upon repeatedly conducting the second step on the processing scheduled area to form the slit recesses each with the second depth.

With such a manufacturing method, first, the metallic plate is set on the bed of the water-jet laser processing device as the workpiece. Then, the high-pressure water stream is injected from the nozzle in the water column, through which the laser beam is transmitted and irradiated onto the metallic plate. In this case, the laser beam impinges upon the processing scheduled area, including a plurality of honeycomb elements, of the metallic plate, thereby forming a slit recess with the second depth shallower than the first depth. Repeatedly forming the slit recesses each with the second depth in the processing scheduled area, causing the slit recesses with the second depths to be formed in the processing scheduled area.

With such a feature, it becomes possible to scatter the magnitude and a temperature of energy of the laser beam irradiated onto the processing scheduled area, thereby enabling the suppression of a variation in width of each slit recess being formed. Further, the slit recesses are formed in the processing scheduled area so as to form the plural honeycomb elements, providing an ease of the high-pressure water stream escaping in three directions from a location where respective corner portions of the neighboring honeycomb elements gather This results in improvement in draining ability of high-pressure water and processed wastage, providing an increase in processing accuracy of the slit recesses. In addition, due to the increase in draining ability of processed wastage, there is no hindrance to the processing due to processed wastage, thereby enabling work time to be shortened.

In such a case, with the second and third steps, the nozzle is placed in a fixed position and the bed is moved relative to the nozzle for thereby processing the metallic plate. This prevents the water column of the high-pressure water stream, being injected from the nozzle, from distorting or swaying. Accordingly, each of the slit recess can have a width with an increased precision, thereby enabling the formation of the slit recesses in a highly reliable manner. That is, work time can be shortened.

Further, the manufacturing method of the related art, use was made of industrial water that contains a slight amount of dusts and oil droplets or the like, which are caused to adhere onto the nozzle with a resultant instability of the water column. However, with the second and third steps of the manufacturing method of the present invention, use is made of high-pressure water, to be injected from the nozzle, which contains an impurity less than 3 μm in size. This prevents foreign particles from adhering onto the nozzle, thereby eliminating the occurrence of air bubbles in the water column resulting from the foreign particles.

Furthermore, no air bubble or dust is present in the high-pressure stream, thereby preventing the laser beam, passing through the water column in multiple reflections, from scattering for thereby reliably performing the laser processing. This results in a remarkable reduction in work time.

During the second and third steps, the high-pressure water stream may be preferably passed through a filter with a pore diameter equal to or less than 2 μm such that water, injected from the nozzle, does not contain an impurity equal to or greater than 3 μm.

Another aspect of the present invention provides a water-jet laser processing device for forming a honeycomb structure molding die having one surface formed with guide holes to admit a raw material and the other surface having slit recesses formed in a honeycomb pattern and each held in fluid communication with each of the guide holes for forming the raw material in a honeycomb structure. The water-jet laser processing device comprises a bed on which a workpiece is set, a nozzle operative to inject a high-pressure water stream in a water column onto the workpiece at a recess forming position thereof, a laser head for guiding the laser beam such that the laser beam is irradiated onto the recess forming position of the workpiece through the water column, a window member disposed between the laser head and the nozzle and made of material having optical transparency to transmit and focus the laser beam, admitted through the laser head, such that the laser beam passes through the water column, a high-pressure water supplier for supplying high-pressure water to the nozzle, and moving means for moving the bed and the nozzle relative to each other to shift a laser beam irradiating position along the recess forming position, wherein the material constituting the window member has Mohs hardness equal to or greater than 9 and a melting point equal to or higher than 2000° C.

With the water-jet laser processing device, a so-called water-jet laser is employed with a structure that allows the laser beam to pass through the water column in multiple reflections for irradiation onto metallic plate serving as the workpiece. The window member, interposed between the laser head and the nozzle, is made of material having optical transparency. This allows the laser beam, emitted through the laser head, to transmit and to be focused, after which the laser beam transmits through the water column. The material constituting the window member has Mohs hardness equal to or greater than 9 and a melting point equal to or higher than 2000° C.

That is, with the water-jet laser processing device, the window member is made of material with hardness equal to or higher than the specified value, described above, and the melting point equal to or higher than the specified temperature mentioned above. Therefore, the laser beam can be brought into contact with and transmitted through the window member with a resultant less development of heat on the surface and inside of the window member. Thus, the window member can have increased durability and heat resistance. This prevents the window member from suffering from deterioration and damage, while eliminating the occurrence of a defect such as a crack or the like. Therefore, the water-jet laser processing device can continuously process the workpiece to form the slit recesses at high precision even in a continuous run for a prolonged period of time.

Thus, with the water-jet laser processing device, among materials having optical transparency, only the specified material with given hardness and melting point is adopted as the material of the window member. This allows the laser beam to have an irradiating characteristic with high precision for a long period of time. Therefore, the laser processing can be maintained at high precision even when operated in a continuous run.

With the water-jet laser processing device, if the window member is made of material that has Mohs hardness less than “9”, then, there is a fear of the window member suffering from deterioration or damage due to the laser beam impinging upon and transmitting through the window member. In addition, if the window member has a melting point less than 2000° C., there is a fear of a crack occurring in the window member due to the development of heat on the surface of or the inside of the window member due to the laser beam transmitting therethrough.

With the water-jet laser processing device, the material constituting the window member may preferably be sapphire.

In this case, the use of sapphire enables a further suppression of deterioration and damage to the window member, enabling further reduction in the occurrence of a defect such as crack or the like.

Further, it becomes possible to adopt a dimension of a deep recess in a narrowed width of, for instance, 40 to 150 μm with a depth of 2 to 3.5 mm. In processing the slit recess with such a dimension, a need arises to have high processing accuracy with a resultant need to perform the processing for a long period of time. Thus, the advantageous effect of the present invention can be particularly exhibited in an effective fashion.

Further, the slit recesses may have various shapes depending on the honeycomb structure body to be formed. Moreover, the slit recesses may be formed in a lattice pattern such as, for instance, a triangular, square shape and hexagonal shape, etc.

Further, examples of the workpiece may include metallic material, ceramics, and other various materials. One example of the metallic material may include, for instance, SKD (alloy tool steel) or the like.

In the present invention, the term “approximately” is meant to include a margin of error in design.

### BRIEF DESCRIPTION OF THE DRAWINGS

FIG. 1A is a perspective view of a honeycomb structure molding die manufactured by a manufacturing method according to the present invention.

FIG. 1B is a plan view of the honeycomb structure molding die as viewed in a direction indicated by an arrow A in FIG. 1A.

FIG. 1C is a perspective view of the honeycomb structure molding die in cross section.

FIG. 2A is a perspective view showing an overall structure of a water-jet laser processing for molding the molding die shown in FIGS. 1A to 1C.

FIG. 2B is an enlarged view showing a circled portion B shown in FIG. 2A.

FIG. 3 is a perspective view showing a metallic plate formed with a columnar shaped protruding portion.

FIG. 4A is a view showing a frame format of a trajectory pattern on which a laser beam travels on a surface of the protruding portion.

FIG. 4B is a schematic view showing how the laser beam repeatedly processes the surface of the protruding portion for forming slit recesses through which water of a water column is drained.

FIG. 5 is a perspective view showing how a metallic plate is moved relative to a nozzle.

FIG. 6 is a perspective view showing an overall structure of a water-jet processing device of an embodiment according to the present invention.

FIG. 7 is a cross sectional view illustrating an internal structure of a water column generating section to show how a window member is placed.

FIG. 8A is a plan view showing a honeycomb structure molding die, formed with slit recesses to form cell walls in a honeycomb compact body, which is manufactured using the water-jet processing device shown in FIG. 6.

FIG. 8B is a fragmentary view showing the slit recesses of the molding die, shown in FIG. 8A, in an enlarged scale.

FIG. 9 is a cross sectional view taken on line C-C of FIG. 8B for illustrating the relationship between the slit recesses and supply holes.

### DETAILED DESCRIPTION OF PREFERRED EMBODIMENTS

Now, a method and apparatus for manufacturing a honeycomb structure molding die of various embodiments according to the present invention will be described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding component parts throughout the several views. Also the following description, it is to be understood that such terms as “external”, “bottom”, “axially”, “front”, “equidistantly” and the like are words of convenience and are not to he construed as limiting terms.

### First Embodiment

Now, a method of manufacturing a honeycomb structure molding die of a first embodiment according to the present invention will be described below with reference to the accompanying drawings. With the present embodiment, the manufacturing method is used for molding a honeycomb compact body by squeezing a ceramic material, composed of a raw material powder and water which are mixed and kneaded, through a molding die. The honeycomb compact body is then fired into an exhaust gas purifying filter (a so-called Diesel Particulate Filter: DPF) for purifying, for instance, pollutants contained in exhaust gases emitted from an engine of a motor vehicle.

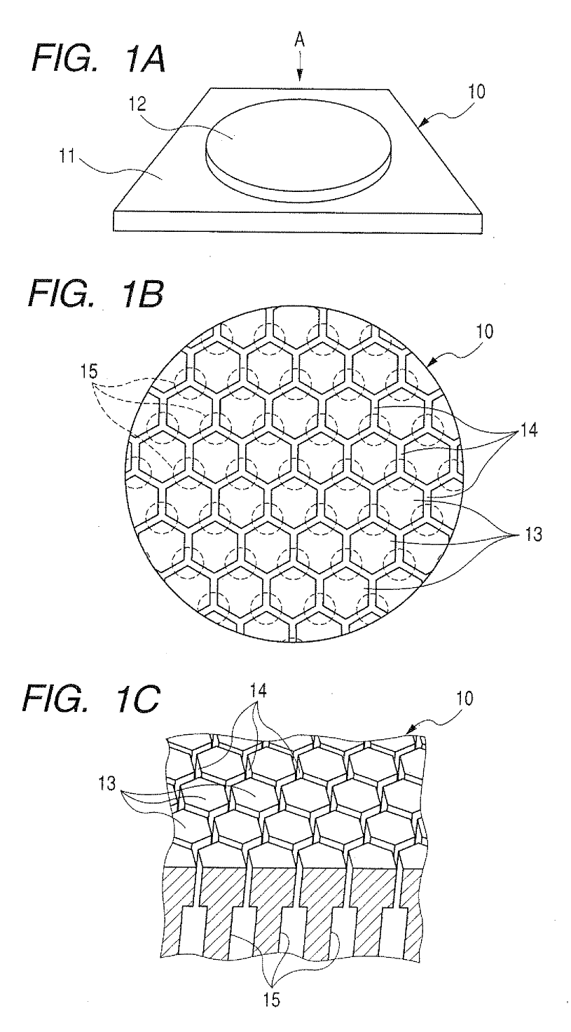

FIGS. 1A to 1C are views showing the honeycomb structure molding die (hereinafter referred to as a “molding die”) manufactured by the method of the present invention. FIG. 1A is a perspective view showing an outline of the molding die 10. FIG. 1B is a view showing the molding die 10 as viewed in a direction as indicated by an arrow A in FIG. 1A. FIG. 1C is a cross-sectional perspective view of the molding die 10 partly in cut away.

As shown in FIG. 1A, the molding die 10 is shown in a structure composed of a plate section 11 and a molding die section 12, formed in a circular shape, which is placed on the plate section 11. As shown in FIG. 1B, the molding die section 12 has a front surface formed with a large number of honeycomb segments 13, each having a surface formed in a hexagonal shape, which are placed in a honeycomb pattern by means of axially extending slit recesses 14. Each of the slit recesses 14 has a depth formed in a first depth. In addition, the plate section 11 and the molding die section 12 correspond to a plate member of the present invention.

As shown in FIG. 1C, further, the molding die section 12 has a bottom wall having a large number of axially extending guide holes 15, formed in equidistantly spaced areas at positions in which three corners of the adjacent honeycomb segments 15 gather, through which a clayish raw material is guided to the slit recesses 14. To this end, the guide holes 15, serving as supply holes, are held in fluid communication with the slit recesses 14, respectively. This causes the raw material, introduced from the guide holes 15, to be squeezed from the molding die section 12 through the slit recesses 14 in a honeycomb structure on the front side of the molding die section 12 such that the honeycomb segments 15 form the raw material into a honeycomb compact body.

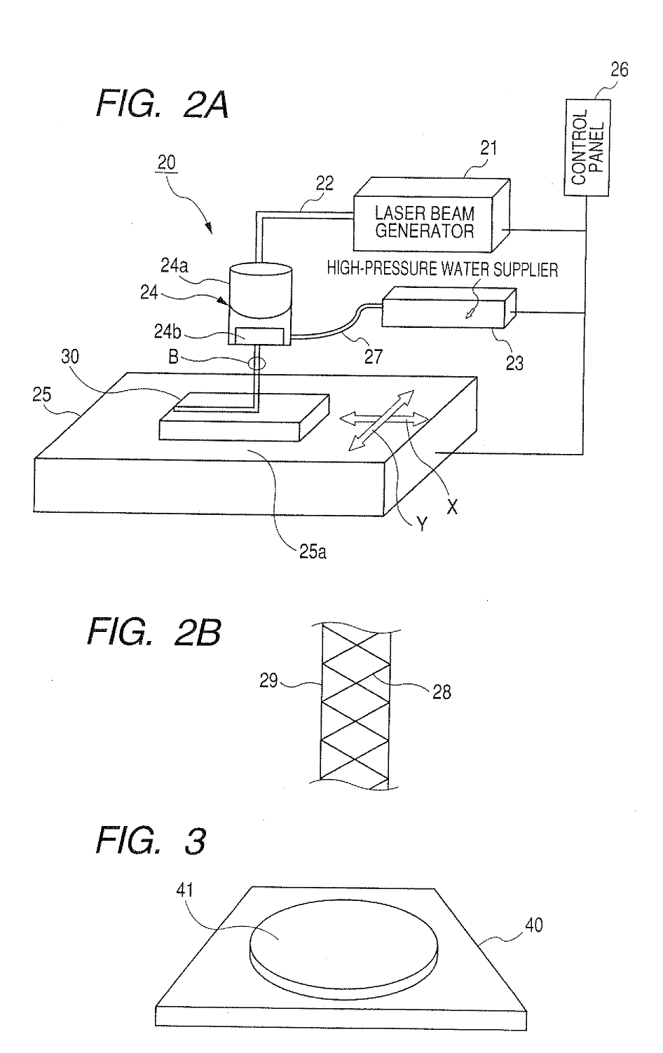

Next, description is made of a method of manufacturing the molding die 10 shown in FIGS. 1A to 1C. With the present embodiment, the molding die 10 is manufactured using a water-jet laser processing device. FIG. 2A is an overall structural view showing a water-jet laser processing device for manufacturing the molding die 10 shown in FIGS. 1A to 1C. FIG. 2B is an enlarged view showing a circled area B shown in FIG. 2A.

As shown in FIG. 2A, the water-jet laser processing device 20 includes a laser beam generator 21, an optical fiber 22, a high-pressure water supplier 23, a processing unit 24, a bed 25 serving as a work holder, and a control panel 26.

The laser beam generator 21 includes a semiconductor laser unit that emits a laser beam for irradiation onto a workpiece 30 for melting the same in a selected pattern to process the workpiece 30. Examples of the semiconductor laser unit includes for instance, a YAG (Yttrium Aluminum Garnet) laser that emits the laser beam at a fixed frequency. In addition, the optical fiber 22 includes a light guide member through which the laser beam, emitted from the laser beam generator 21, to the processing unit 24.

The high-pressure water supplier 23 generates a high-pressure water stream for washing out processing wastage resulting from the workpiece 30. To this end, the high-pressure water supplier 23 is connected to a water tank (not shown) to be supplied with water and pressurizes water to generate a stream of high-pressure water remaining at a pressure of 20 kg/mm². Further, for water to be used for generating high-pressure water, water with no inclusion of impurities such as, for instance, tap water is adopted. More particularly, use is made of water that does not contain foreign particles equal to or greater than 3 μm in size. The stream of high-pressure water, generated in the high-pressure supplier 23, is supplied to the processing unit 24 through a delivery conduit 27.

With the present embodiment, respective filters are provided in a water drain port of the water tank (not shown), a water channel provided inside the high-pressure supplier 23 and a junction between the delivery tube 27 and the processing unit 24. Each of these filters has a pore diameter equal to or less than 2 μm. By using such filters, no foreign particles equal to or greater than 3 μm are contained water supplied to the processing unit 24.

The processing unit 24 includes a laser head 24a and a water column generating section in the form of a nozzle 24b and serves to process the workpiece 30. The processing unit 24 takes the form of a vessel having one side on which the laser head 24a is provided and the other side on which the nozzle 24b is fixedly secured. Of these component parts of the processing unit 24, the laser bead 24a includes a protection window (not shown), made of glass, which serves to focus the laser beam emitted from the laser beam generator 21 and guided through the optical fiber 22.

As shown in FIG. 2B, the nozzle 24b is fixedly secured to a bottom end of the laser head 24a and allows the laser beam 28, focused with the protection window, to be irradiated onto the workpiece 30, while injecting the stream of high-pressure water, supplied from the high-pressure water supplier 23, in a water column 29 in the form of a water jet. That is, the other side of the vessel, forming the processing unit 24, is closed with the protection window of the laser head 24a, thereby defining a closed compartment. The high-pressure water stream is supplied to the closed compartment through the delivery conduit 27 and injected onto the workpiece 30 from the nozzle 24b.

Further, since the water column 29 is formed of the stream of high-pressure water with straight-head traveling capability to wash out processing wastage occurring from the workpiece 30 during processing with the laser beam. That is, the laser beam 28 travels through the water column 29 in multiple reflections on a boundary surface between atmospheric air and the water column 29 to reach the workpiece 30. This allows the workpiece 30 to be melted for processing. The processing unit 24, provided with such a laser head 24a and the nozzle 24b, is fixed in position.

The bed 25 takes the form of a table having a mount surface 25a on which the workpiece 30 is placed. The bed 25 includes a driver section (not shown), which is arranged to move the mount surface 25a in a planar direction.

The control panel 26 controls operations of the laser beam generator 21, the high-pressure water supplier 23 and the bed 25. The control panel 26, including a control device and operation buttons or the like, controllably drives the semiconductor laser unit of the laser beam generator 21, the high-pressure water supplier 23 and the bed 25 in accordance with processing programs that are preliminary set. The foregoing is an overall structure of the water-jet laser processing device 20.

Next, description is made of a method of manufacturing the molding die 10, shown in FIG. 1, using the water-jet laser processing device 20 set forth above. First, a square-shaped hot processing metallic plate is prepared as the workpiece 30. Such a metallic plate that is 200 mm long and 200 mm width with a thickness of 15 mm.

Subsequently, a bottom surface of the metallic plate is formed with the guide holes 15 by using a mortising device such as, for instance, drilling or the like. Thereafter, among various surfaces of the metallic plate, outer peripheral portions are cut to form a columnar shaped protruding section with a diameter of, for instance 150 mm.

FIG. 3 is a perspective view showing the metallic plate 40 formed with the columnar shaped protruding section 41 The metallic plate 40, from which the protruding section 41 is removed, corresponds to the plate section 11 shown in FIG. 1A.

The metallic plate 40, corresponding to the workpiece 30, is fixedly placed on the mount surface 25a of the bed 25 of the water-jet laser processing device 20. In this case, the metallic plate 40 is fixedly placed on the bed 25 so as to allow the protruding section 41 of the metallic plate 40 to face the processing unit. Such a step is referred to as a first step of the present invention

With the metallic plate 40 fixedly placed on the bed 25, an operator manipulates the control panel 26 such that the laser beam 28 is irradiated onto the protruding section 41 while causing the nozzle 24b to inject the water column 29 thereto in accordance with the processing programs to begin processing the surface of the protruding section 41. With the present embodiment, an overall surface area of the protruding section 41 serves as a processing scheduled area. In addition, the processing scheduled area may cover an entire surface of the protruding section 41 or a part of the entire surface.

With the present embodiment, in forming the slit recesses 14 on the surface of the protruding section 41 of the metallic plate 40, first, the slit recesses 14 are formed on the processing scheduled area, i.e., the entire surface of the protruding section 41 covering a first row to a final row. In addition, such a forming step is referred to as a second step of the present invention.

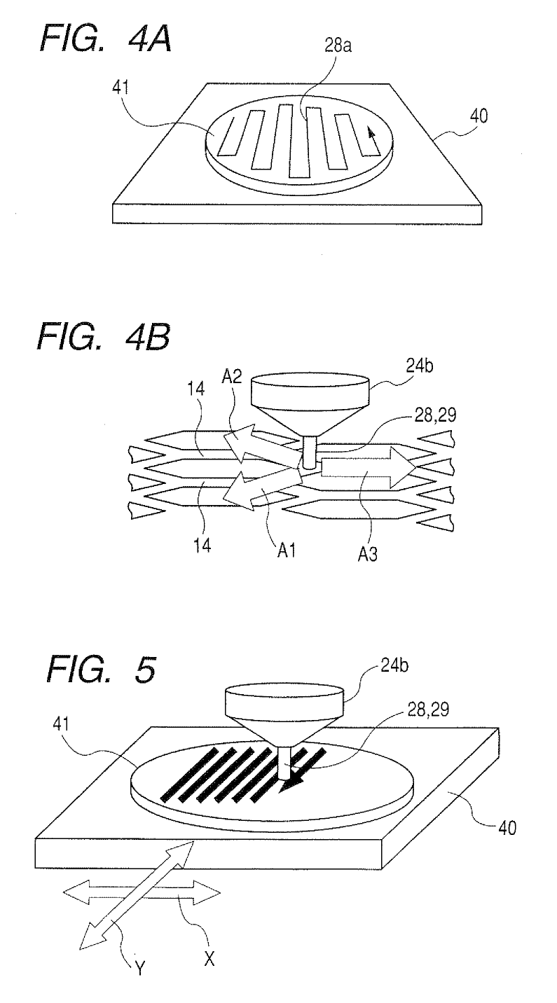

FIG. 4A is a perspective view showing a frame format of a trajectory pattern 28a along which the laser beam 28 travels on the surface of the protruding section 41. As shown in FIG. 4A, a first step of processing is not executed to form the slit recesses 14 each with a first depth but to form the slit recesses each with a second depth shallower than the first depth.

More particularly, the laser beam 28 is reciprocated on the surface of the protruding section 41 one time to process a part of the slit recesses 14 on the first row and the laser beam 28 is reciprocated on a processing scheduled area of the slit recesses 14 on a second row. Repeatedly conducting such processing steps allows an entire surface of the protruding section 41 of the metallic plate 40 to be formed with the recesses each with a depth of, for instance, 0.05 mm. Thereafter, the laser beam 28 is reciprocated again one time on the first row to process the surface of the protruding section 41. Likewise, laser processing is repeatedly conducted up to the final row. In addition, such a forming step is referred to as a third step of the present invention.

With the laser processing steps repeatedly conducted to form the recesses on the entire surface of the protruding section 41 in such a way, the slit recesses 14 are formed each with the first depth required for the protruding section 41. During such laser processing, a water stream of the water column 29 is drained in direction as indicated by arrows A1 to A3.

More particularly, as set forth above, the laser processing step is repeatedly conducted for the entire surface of the protruding section 41 of the metallic plate 40, resulting in the occurrence of hexagonal recesses, formed on the surface of the protruding section 41 and serving as the slit recesses 14, with processing conducted one time. Accordingly, as shown in FIG. 4B, the water stream of the water column 29 can escape from the recesses in three directions A1 to A3 at areas where respective corners of the respective hexagonal honeycomb elements 13 gather, thereby enabling a reduction in water to accumulate.

As the laser processing is carried out so as to form the recesses each with a certain depth, the recesses have progressively increasing depths. This allows airspaces, oriented in three directions, to be widened for draining the water stream of the water column 29. This enables an increase in drainage behavior of the water with an increase in frequency of the steps of forming the recesses.

Thus, the laser forming is carried out with a resultant increase in drainage behavior of water to provide an ease of ejecting the processing wastage in comparison to the related an method in which repeatedly executing the steps of processing the slit recesses 14 by one time in a specified depth allows the slit recesses 14 to be formed on the entire surface of the protruding section 41. Thus, no adverse affect of the processing wastage is present, enabling a reduction in variation of the width of the slit 14 with a resultant increase in processing accuracy.

Further, the laser processing can be performed so as to disperse the magnitude and temperature, etc., of energy of the laser beam 28 that varies in a period of processing for a long period of time. This enables the suppression of a variation in width of the recess to be formed on each row.

In forming the recesses using the laser beam 28 in such a manner set forth above, the processing unit 24 is fixed in position and the bed 25 is driven in a planar direction of the mount surface 25a on which the metallic plate 40 is mounted. That is, the surface of the protruding section 41 of the metallic plate 40 is moved relative to the nozzle 24b of the processing unit 24 in a traveling pattern shown in FIG. 5.

As shown in FIG. 5, by driving the mount surface 25a of the bed 25 (see FIG. 2A) on a planar direction in X- and Y-axes with the nozzle 24b, serving as an ejecting port, of the water-jet fixed in position, the metallic plate 40 is moved in conformity to a pattern of the slit recesses 14 to be targeted as objects to be processed. Thereafter, the surface of the protruding section 41 is subjected to the laser processing steps.

Thus, placing the nozzle 24b in the fixed place while moving the metallic plate 40 enables the prevention of the swaying of the water column 29 of high-pressure water being injected from the nozzle 24b such that no water column 29 is distorted. Therefore, this prevents the swaying of the laser beam 28 in the water column 29 in multiple reflections, thereby enabling improvement in accuracy of a width of each recess to be formed.

Further, a tap water is used as water forming the water column 29 injected from the nozzle 29b and passed through the filter with the pore diameter of approximately 2 μm, upon which water is pressurized to form high-pressure water. High-pressure water is supplied to the processing unit 24. Thus, no foreign particle equal to or greater than 3 μm is contained in water to be supplied to the processing unit 24.

Therefore, no foreign particle adheres onto a spout of the nozzle 24b and no impurity accumulates on the spout. This prevents the water column 29, injected from the nozzle 24b, from distorting due to the impurity adhered to the spout, enabling the water column 29 to be injected in a stable manner. Thus, the laser beam 28 passes through the water column 29 in multiple reflections for irradiation onto the surface of the protruding section 41 in a stable manner, enabling the laser beam 28 to perform the processing at high precision.

In such a way mentioned above, the surface of the protruding section 41 of the metallic plate 40 is formed with the slit recesses each with a specified depth. Thus, the molding die 10 is completed in the structure shown in FIG. 1.

As set forth above, the present embodiment has a feature in that repeatedly forming the recess with a fixed depth on the surface of the protruding section 41 of the metallic plate 40 allows the slit recesses 14 to be formed. This allows water of the water column 29 to escape in the three directions with a resultant improvement in draining capability of water and ejecting ability of the processing wastage. In addition, the laser beam 28 can be irradiated onto the surface of the protruding section 41 in a uniform manner, making it possible to improve processing precision of the slit recesses 14.

Further, the present embodiment has another feature in that the processing unit 24 is placed in the fixed position and the bed 25 is available to move the metallic plate 40, serving as the workpiece 30, relative to the processing unit 24. This prevents the water column 29 from swaying, thereby improving the width of the slit 14.

Further, another feature resides in the fact that the tap water is used as water for creating high-pressure water while using the filter with the pore diameter of approximately 2 μm. This makes it possible to prevent water, supplied to the processing unit 24, from containing foreign particles of approximately 3 μm. That is, since no foreign particle is adhered onto the nozzle 24b, no air bubble occurs in the water column 29. Moreover, no bubble or dust is present inside the water column 29, enabling the laser beam, passing through the water column 29 in multiple reflection, to be prevented from scattering.

With such a method mentioned above, no hindrance occurs in processing the surface of the protruding section 41. As a consequence, the laser beam can reliably process the protruding section 41, making it possible to complete the processing within a shortened period of time.

### Second Embodiment

Now, a water-jet laser processing device of a second embodiment according to the present invention will be described below in detail.

The water-jet laser processing device 20A of the present embodiment differs from the water-jet laser processing device shown in FIGS. 2A and 2B in respect of a particular feature. Thus, the water-jet laser processing device of the present embodiment will be discussed with a focus on such a particular feature.

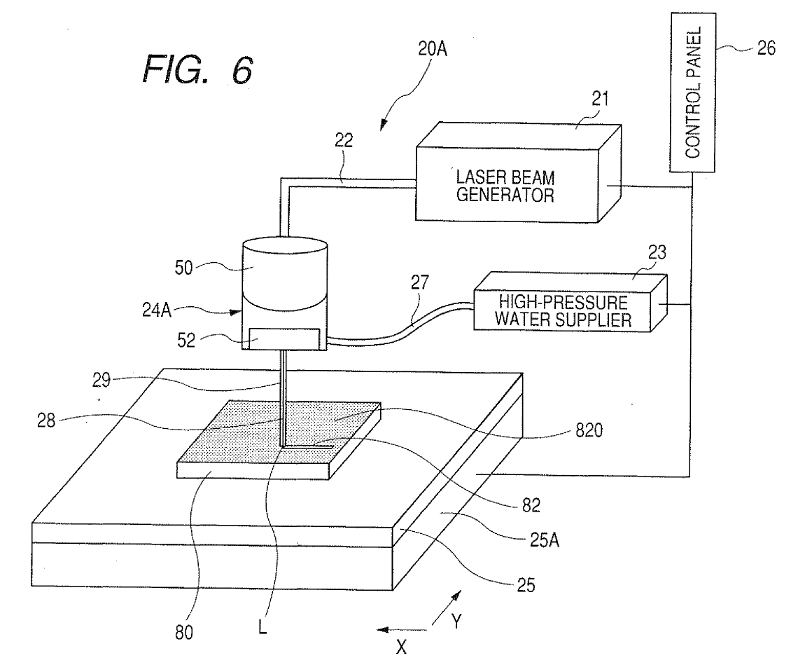

As shown in FIG. 6, the water-jet laser processing device 20A of the present embodiment includes a processing unit 24A, comprised of a laser head 50 and a water column generating section 52, and a drive section 25A connected to a control panel 26 for moving the bed 25 in X- and Y-axes relative to the processing unit 24A.

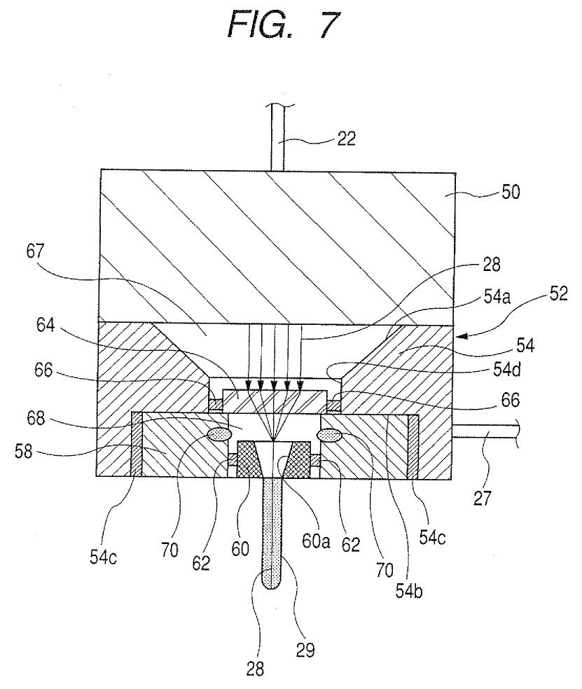

As shown in FIG. 7, the water column generating section 52 includes a main body 54 having one surface fixedly secured to a bottom wall of the laser head 50 and formed with a conical surface 54a and another surface formed with a concaved portion 54b, a nozzle holder 58 accommodated in the concaved portion 54b and screwed into the main body 54 via a threaded portion 54c, and a cylindrical nozzle 60, accommodated in an axially extending cylindrical bore 58a of the muzzle holder 58, which has an ejecting spout 60a through which a high-pressure water stream is ejected to form a water column 29. The nozzle holder 58 holds the nozzle 60 in a fixed place by means of a retaining member 62 press-fitted between the nozzle holder 58 and the nozzle 33.

As shown in FIG. 7, further, the main body 54 of the water column generating section 52 is formed with a central bore 54d that accommodates therein a window member 64 disposed between the laser head 50 and the nozzle 60. The window member 64 is made of material having an optical transparency to transmit a laser beam 28, guided from the laser head 50, in a focused state while permitting the laser beam 28 to be incident through the water column 29. The main body 54 retains the window member 64 in a fixed place by means of a fixing member 66.

With the present embodiment, sapphire is employed as the material forming the window member 64. Sapphire has a Mohs hardness of 9 and a melting point at a temperature of 2053° C., allowing the window member 64 to have high hardness and excellent heat resistance.

As shown in FIG. 7, furthermore, defined between the window member 64 and laser head 50 is a channel airspace 67 that serves as a channel through which the laser beam 28, emitted from the laser head 50, is transmitted.

Moreover, a guide chamber 68 is provided inside the cylindrical bore 58a of the nozzle holder 58 in a position between the window member 64 and the nozzle 60 in fluid communication with the high-pressure water supplier 23 through the delivery conduit 27 to guide the high-pressure water stream therethrough. To this end, the nozzle holder 58 is formed with guide ports 70 that are opened to the guide chamber 68.

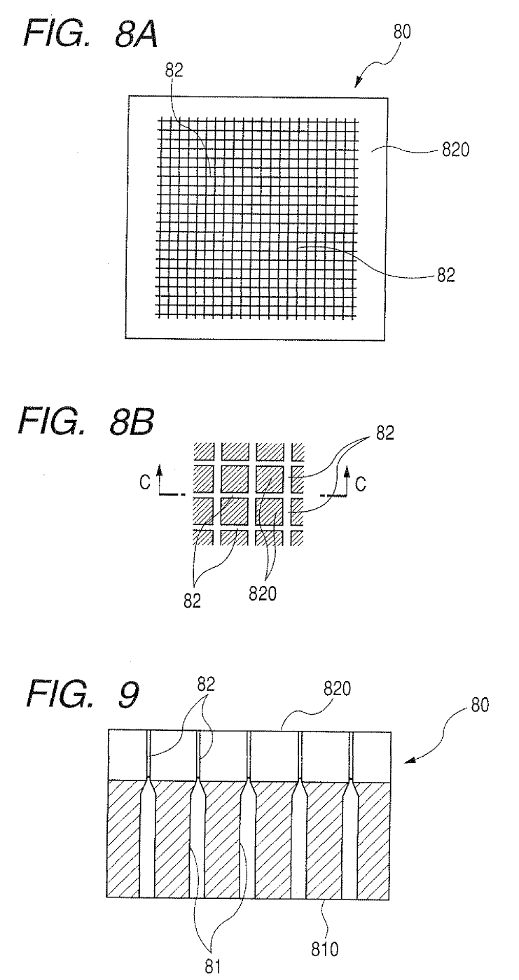

Next, a method of manufacturing a honeycomb structure molding die 80 using the water-jet laser processing device 20A of the present embodiment will be described below with reference to FIGS. 8A and 8B.

As shown in FIGS. 8A and 8B and FIG. 9, the honeycomb structure molding die 80, to be manufactured in this Example, has guide holes 81 serving as supply holes through which raw material is supplied, slit recesses 82 formed in a lattice pattern and held in fluid communication with the supply holes 81, respectively, to form the raw material in a honeycomb shape. The slit recesses 82 are formed on a slit recess forming surface 820 in a squared lattice pattern. Each of the slit recesses 82 has a width of 90 μm with a depth of 2.5 mm.

In manufacturing the honeycomb structure molding die 80, first, a molding die base material (workpiece) is prepared. The molding die base material 30 has a hole forming surface 810 in opposition to the slit recess forming surface 820 (see FIG. 9). The hole forming surface 810 of the honeycomb structure molding die 80 is preliminary formed with the supply holes 81 using a drill.

Further, for the honeycomb structure molding die 80, use was made of a square shape metallic plate that is 200 mm long and 200 mm wide with a thickness of 15 mm. The honeycomb structure molding die 80 had a material of SKD61 (alloy tool steel). It is of course to be appreciated that other material than such alloy tool steel may be adopted in any other dimension.

Next, the slit recesses 82 are formed using the water-jet laser processing device 20A shown in FIG. 6.

More particularly, first, the molding die base material 80 is set on the bed (holder section) 25. Then, a high-pressure water stream is injected onto the molding die base material 80 through the nozzle 60 of the water column generating section 52, thereby forming the water column 29. Meanwhile, the laser beam 28 is transmitted through the water column 29 to be irradiated onto the molding die base material 80 (see FIGS. 6 and 7). In this case, the high-pressure water stream, forming the water column 29, was set to a water pressure of 230 kgf/cm² and the laser beam 28 was set to a pulse power of 1400 W.

When this takes place, as shown in FIGS. 6 and 7, the high-pressure water stream, supplied from the high-pressure water supplier 23 to the water column generating section 52 through the delivery conduit 27, is admitted through the guide ports 70 of the water column generating section 52 into the guide chamber 68. Then, the high-pressure water stream passes through the ejecting spout 60a of the nozzle 60 and is injected in the form of the water column 29.

As shown in FIGS. 6 and 7, further, the laser beam 28, delivered from the laser beam generator 21 through the optical fiber 22, is transmitted through the laser head 50 to pass through the channel airspace 67 into the window member 64 to be focused. Thereafter, the laser beam 28 passes through the guide chamber 68 and the ejecting spout 60a of the nozzle 60 to be incident through the water column 29. Thus, the laser beam 28 is transmitted through the water column 29 and irradiated onto the surface of the molding die base material 80.

Further, the bed 25 is moved in the X- and Y-axis directions (see FIG. 6) by the action of the drive section 25A, thereby repeatedly moving a laser irradiating position L on the molding die base material 80 along a recess forming pattern. In addition, a traveling speed of the laser irradiating position L relative to the molding die base material (workpiece) 80 was set to a value of 150 to 240 mm/min and the number of repetition frequencies was set to 70 times. This causes the slit recesses 82 to be formed with a width of 90 μm in a depth of 2.5 mm.

The foregoing steps results in the formation of the honeycomb structure molding die 80 with a structure shown in FIGS. 8A and 8B and FIG. 9.

The water-jet laser processing device 20A has advantageous effects listed below.

As set forth above, with the water-jet laser processing device 20A, the water column 29 is formed so as to extend from the nozzle 60 to the molding die base material 80 set on the bed 25 and the laser beam 28 is transmitted through the water column 29 for irradiation onto the molding die base material 80. Thus, the molding die base material 80 is formed with the slit recesses by a so-called water-jet laser processing. With the water-jet laser processing device 20A, disposed between the laser head 50 and the nozzle 60 is the window member 64, made of material having optical transparency, which functions to transmit and focus the laser beam 28, emitted from the laser head 50, such that the laser beam 28 is incident through the water column 29. In addition, the window member 64 is made of material having Mohs hardness equal to or greater than a value of 9 and a melting point equal to or higher than a temperature of approximately 2000° C., allowing the window member 64 to have high hardness and excellent heat resistance.

That is, with the present embodiment, for the window member 64, use is made of material having the hardness equal to or higher than a specified value and the melting point equal to or higher than a specified temperature. Therefore, the laser beam 28 can be brought into contact with and transmitted through the window member 64 with a resultant less development of heat on the surface and inside of the window member 64. Thus, the window member 64 can have increased durability and heat resistance. This prevents the window member 64 from suffering from deterioration and damage, while eliminating the occurrence of a defect such as a crack or the like. Therefore, the water-jet laser processing device 20A can continuously process the workpiece to form the slit recesses at high precision even when continuously operated for a prolonged period of time.

With the present embodiment, further, the window member 64 is made of material such as sapphire. This enables a further reduction in the occurrence of deterioration and damage of the window member 64, enabling a further prevention of a defect such as a crack or the like.

Thus, with the water-jet laser processing device 20A, among materials having optical transparency, the specified material is adopted for the window member 64 to have the specified hardness and melting point. This enables the laser beam 28 to have an irradiating characteristic with high precision for a long period of time. As a consequence, the workpiece can be processed at high precision even when processed in a continuous operation for a prolonged period of time.

(Evaluation Test)

The water-jet laser processing device 20A of the present embodiment was subjected to an evaluation test in a manner as described below to evaluate durability of the window member 64.

In the evaluation test, the workpiece 80 was formed with the slit recesses 82 in a continuous run for a prolonged period of time using the water-jet laser processing device 20A, upon which a status of the window member 64 was checked. In this test, sapphire was used as the material of the window member 64. Also, the processing condition was set to the same condition of the present embodiment as mentioned above.

Further, as a comparison device, a water-jet laser processing device of the related art, incorporating a window member made of quartz crystal, was prepared and the same evaluation test as that described above was conducted.

As a result of evaluations, the comparison device suffered from remarkable deterioration and damage in a continuous run for 72 hours and in the event of a severe result, a crack occurred.

Meanwhile, with the apparatus of the present embodiment, no deterioration or damage occurred on the window member, even when operated in a continuous run for the prolonged period of time, and no crack occurred in the window member.

From such a result, it is turned out that the manufacturing apparatus of the present embodiment can prevent the occurrence of defect in the window member even when operated in the continuous run for the long period of time while enabling the processing to be performed at high precision.

### Other Embodiment

While the embodiments mentioned above uses tap water as water for creating high-pressure water, it doesn't matter if use is made of pure water containing no impurity or foreign particles. This enables the water column 29 to be formed in a stable manner, thereby improving a processing time and processing accuracy.

While the specific embodiment of the present invention has been described in detail, it will be appreciated by those skilled in the art that various modifications and alternatives to those details could be developed in light of the overall teachings of the disclosure. Accordingly, the particular arrangement disclosed is meant to be illustrative only and not limited to the scope of the present invention, which is to be given the full breadth of the following claims and all equivalents thereof.

What is claimed is:

1. A method of manufacturing a honeycomb structure molding die, operative to form a honeycomb compact body from a clayish raw material, which is made of a plate-like member, having one surface formed with guide holes to admit the raw material and the other surface formed with slit recesses in a honeycomb pattern, each having a first depth and held in fluid communication with each of the guide holes, which has a plurality of honeycomb elements divided by the slit recesses, respectively, the method comprising:
a first step of setting a metallic plate as a workpiece on a water-jet laser processing device including a laser beam generator for generating a laser beam, a high-pressure water generator for creating a high-pressure water stream, a nozzle for irradiating the laser beam, delivered from the laser beam generator, while injecting a high-pressure water stream delivered from the high-pressure water generator, and a bed carrying thereon a workpiece;
a second step of causing the high-pressure water stream to be injected from the nozzle in a water column while passing the laser beam through the water column in multiple reflection on a boundary surface between the water column and an outside to cause the laser beam to be irradiated onto the metallic plate for thereby forming slit recesses, each with a second depth shallower than the first depth, on a processing scheduled area, containing the plurality of honeycomb elements, of the metallic plate; and
a third step of forming the slit recesses, each with the first depth, on the processing scheduled area upon repeatedly conducting the second step on the processing scheduled area to form the slit recesses each with the second depth.

2. The method of manufacturing a honeycomb structure molding die according to claim 1, wherein:
the second and third steps are conducted while the nozzle is placed in a fixed position and the bed is moved relative to the nozzle for thereby processing the metallic plate.

3. The method of manufacturing a honeycomb structure molding die according to claim 1, wherein:
the second and third steps are conducted with the water column injected from the nozzle and formed of water containing an impurity equal to or less than 3 μm.

4. The method of manufacturing a honeycomb structure molding die according to claim 1, wherein:
during the second and third steps, the high-pressure water stream is passed through a filter with a pore diameter equal to or less than 2 μm such that water, injected from the nozzle, does not contain an impurity equal to or greater than 3 μm.

5. The method of manufacturing a honeycomb structure molding die according to claim 1, wherein:
the high-pressure water stream has a water pressure of approximately 230 kgf/cm² and the laser beam has a pulse power of approximately 1400 W.

6. A water-jet laser processing device for forming a honeycomb structure molding die having one surface formed with guide holes to admit a raw material and the other surface having slit recesses formed in a honeycomb pattern and each held in fluid communication with each of the guide holes for forming the raw material in a honeycomb structure, the water-jet laser processing device comprising:
a bed on which a workpiece is set;
a nozzle operative to inject a high-pressure water stream in a water column onto the workpiece at a recess forming position thereof;
a laser head for guiding the laser beam such that the laser beam is irradiated onto the recess forming position of the workpiece through the water column;
a window member disposed between the laser head and the nozzle and made of material having optical transparency to transmit and focus the laser beam, admitted through the laser head, such that the laser beam passes through the water column;
a high-pressure water supplier for supplying high-pressure water to the nozzle; and
moving means for moving the bed and the nozzle relative to each other to shift a laser beam irradiating position along the recess forming position;
wherein the material constituting the window member has Mohs hardness equal to or greater than 9 and a melting point equal to or higher than 2000° C.

7. The water-jet laser processing device according to claim 6, wherein:
the material constituting the window member is sapphire.

8. The water-jet laser processing device according to claim 6, further comprising:
a main body having a channel airspace to pass the laser beam admitted through the laser head and accommodating therein the window member;
a nozzle holder fixedly mounted on the main body to hold the nozzle in a position spaced apart from the window member; and
a guide chamber defined between the window member and the nozzle in fluid communication with high-pressure water supplier to be supplied with the high-pressure water for injection through the nozzle.

9. The water-jet laser processing device according to claim 6, wherein:
the moving means comprises a drive section for moving the bed relative to the nozzle in X- and Y-axes.
